(19) United States
(12) Patent Application Publication
(10) Pub. No.: US 2011/0122840 A1
(43) Pub. Date: May 26, 2011

(54) METHOD FOR CONTROLLING INTER-FREQUENCY HAND-OFF IN COGNITIVE RADIO BASED CELLULAR RELAY COMMUNICATIONS NETWORK

(75) Inventor: Seung Mo KIM, Seoul (KR)

(73) Assignee: SAMSUNG ELECTRO-MECHANICS CO., LTD., Gyunggi-do (KR)

(21) Appl. No.: 12/770,899

(22) Filed: Apr. 30, 2010

(30) Foreign Application Priority Data
Nov. 26, 2009 (KR) 10-2009-0115330

(51) Int. Cl. H04W 36/12

(52) U.S. Cl. 370/331

(57) ABSTRACT

There is provided a method for controlling inter-frequency hand-off in a cognitive radio based cellular relay communications network, the method including: receiving the inter-frequency hand-off request from mobile stations and receiving information on RS-signal strength and BS-signal strength, from the mobile stations; when the base stations receive the inter-frequency hand-off request, acquiring empty channel information receiving cognitive radio band information including the empty channel information by requesting the cognitive radio band information to the relay stations having the empty channel information based on a cognitive radio technology; calculating RS-throughput corresponding to data throughput between the relay stations and BS-throughput corresponding to data throughput between the base stations by using the information on the RS-signal strength and the BS-signal strength and empty channel state information in the cognitive radio band information; and when the RS-throughput is higher than the BS-throughput, instructing the mobile station to perform the inter-frequency hand-off.

### CROSS-REFERENCE TO RELATED APPLICATIONS

This application claims the priority of Korean Patent Application No. 10-2009-0115330 filed on Nov. 26, 2009, in the Korean Intellectual Property Office, the disclosure of which is incorporated herein by reference.

### BACKGROUND OF THE INVENTION

1. Field of the Invention

The present invention relates to a method for controlling an inter-frequency hand-off used in a cognitive radio based cellular relay communications network, and more particularly, to a method for controlling an inter-frequency hand-off in a cognitive radio based cellular relay communications network capable of reducing inter-channel signal interference in a complex multi-cell network and improving signal throughput by performing the inter-frequency hand-off using empty channels based on CR (Cognitive Radio) technology.

2. Description of the Related Art

In general, each of a plurality of BSs (base stations), installed in a cellular relay communications network, has cells that can provide services in a predetermined region.

However, since a shadow region is generated in regions such as a subway or an area adjacent to a building, RSs (relay stations) are needed between the plurality of base stations in order to improve throughput in the shadow region.

FIG. 1 is a configuration diagram of a cellular relay communications network.

Referring to FIG. 1, the cellular relay communications network includes a plurality of base stations 30 that service cellular communications with a mobile station 10 and RSs (relay stations) that improve throughput in shadow regions, such as a subway or an area adjacent to a building where service quality provided by the base station 30 is deteriorated, to provide a good quality of service.

In the cellular relay communications network, communications cells are complicatedly formed in the plurality of base stations and the plurality of relay stations that are installed between the plurality of base stations.

However, in the cellular relay communications network including the relay stations, the BSs (base stations) and the RSs (relay stations) are used together and the plurality of base stations and the plurality of relay stations use the same frequency channel, such that signal interference can occur between the plurality of channels, thereby remarkably degrading the strength and throughput of the signal temporally and locally.

### SUMMARY OF THE INVENTION

An aspect of the present invention provides a method for controlling an inter-frequency hand-off in a cognitive radio based cellular relay communications network capable of reducing inter-channel signal interference in a complex multi-cell network and improving signal throughput by performing the inter-frequency hand-off using empty channels based on a CR (cognitive radio) technology.

According to an aspect of the present invention, there is provided a method for controlling an inter-frequency hand-off in a cognitive radio based cellular relay communications network including: receiving the inter-frequency hand-off request from mobile stations and receiving information on RS-signal strength, which is a signal strength with relay stations, and BS-signal strength, which is a signal strength with the base stations, from the mobile stations; when the base stations receive the inter-frequency hand-off request, acquiring empty channel information receiving cognitive radio band information including the empty channel information by requesting the cognitive radio band information to the relay stations having the empty channel information based on a cognitive radio technology; calculating RS-throughput corresponding to data throughput between the relay stations and BS-throughput corresponding to data throughput between the base stations by using the information on the RS-signal strength and the BS-signal strength and empty channel state information in the cognitive radio band information; and when the RS-throughput is higher than the BS-throughput, instructing the mobile station to perform the inter-frequency hand-off.

According to another aspect of the present invention, there is provided a method for controlling inter-frequency hand-off in a cognitive radio based cellular relay communications network according to the present invention may include: requesting inter-frequency hand-off from mobile stations to base stations in the case of a shadow area; receiving the inter-frequency hand-off request from the mobile stations and receiving information on RS-signal strength, which is signal strength with the relay stations and BS-signal strength, which is a signal strength with the base station, from the mobile stations, along with the inter-frequency hand-off request; when the base stations receive the inter-frequency hand-off request, acquiring empty channel information receiving cognitive radio band information including the empty channel information by requesting the cognitive radio band information to the relay stations having the empty channel information based on a cognitive radio technology; calculating RS-throughput DR-RS corresponding to data throughput between the relay stations and BS-throughput DR-BS corresponding to data throughput between the base stations by using the information on the RS-signal strength RSS-RS with the relay station and the BS-signal strength RSS-BS with the base station and the empty channel state information in the cognitive radio band information; when the RS-throughput DR-RS is higher than the BS-throughput DR-BS, instructing the mobile stations 10 to perform the inter-frequency hand-off; and allowing the mobile stations to perform the inter-frequency hand-off according to the inter-frequency hand-off instruction.

According to the first and second aspects of the present invention, the calculating of the throughput includes: when exclusive authority exists in the empty channel state information, calculating the number of channels useable by a cognitive user by using useable probability of the cognitive user for each of the empty channels included in the cognitive radio band information; and calculating the RS-throughput and the BS-throughput, respectively, by using the number of channels and the information on the RS-signal strength and the BS-signal strength.

In addition, the calculating of the throughput includes: when the exclusive authority does not exist in the empty channel state information, calculating the number of maximally useable channels in the range where an interference degree occurring between the cognitive user and the existing user for each of the empty channels included in the cognitive radio band information does not exceed a predetermined interference threshold; and calculating the RS-throughput and the BS-throughput, respectively, by using the number of maximally useable channels and the information on the RS-signal strength and the BS-signal strength.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a cellular relay communications network;

FIG. 2 is a flowchart illustrating a method for controlling an inter-frequency hand-off in a cognitive radio based cellular relay communications network according to the present invention;

FIG. 3 is a structural diagram of cognitive radio channel information according to the present invention;

FIG. 4 is a first exemplified diagram of calculating of throughput according to the present invention; and

FIG. 5 is a second exemplified diagram of calculating of throughput according to the present invention.

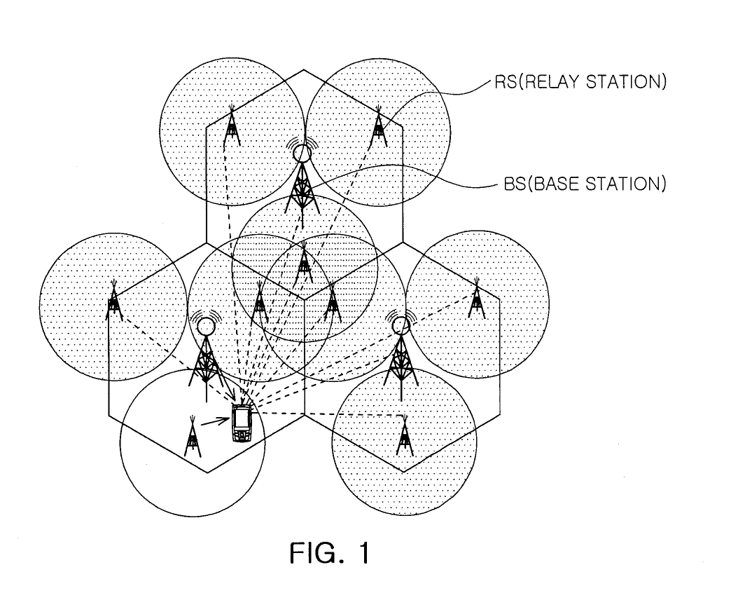

### DETAILED DESCRIPTION OF THE PREFERRED EMBODIMENT

Exemplary embodiments of the present invention will now be described in detail with reference to the accompanying drawings.

The present invention is not limited to the exemplary embodiments, but the exemplary embodiments are used to help understanding of the technical spirit of the present invention. Throughout the drawings referenced in the present invention, like components having substantially the same configurations and functions will be denoted like reference numerals.

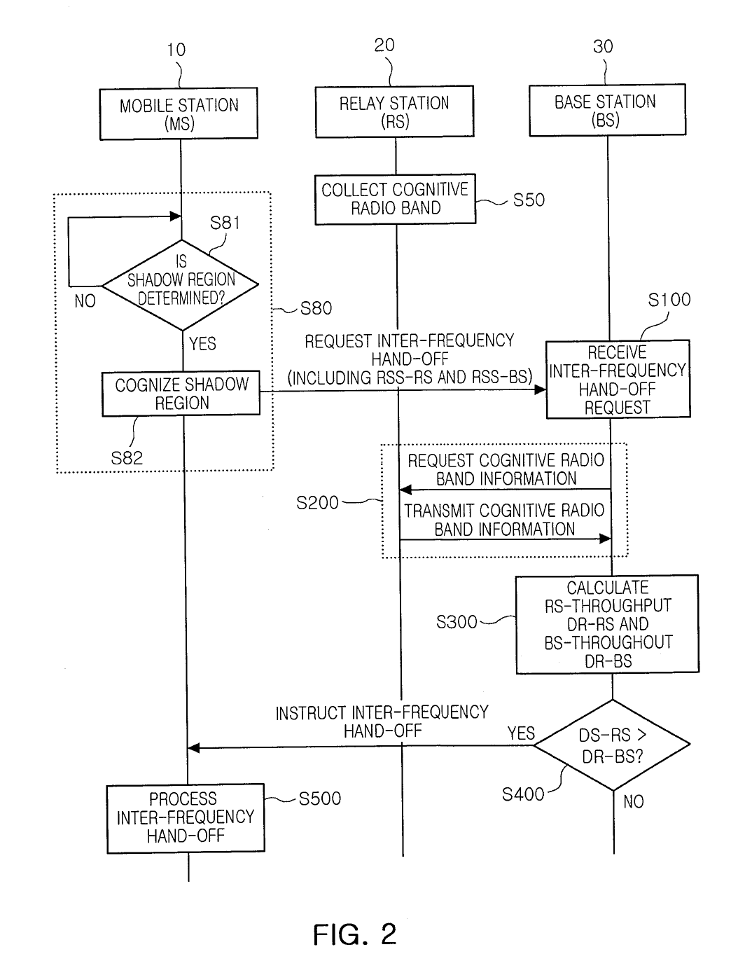

FIG. 2 is a flowchart illustrating a method for controlling an inter-frequency hand-off in a cognitive radio based cellular relay communications network according to the present invention. Referring to FIG. 2, a method for inter-frequency hand-off in a cognitive radio based cellular relay communications network according to the present invention may include: requesting inter-frequency hand-off from mobile stations 10 to base stations 30 in the case of a shadow area (S80); receiving the inter-frequency hand-off request from the mobile stations 10 and receiving information on RS-signal strength RSS-RS, which is signal strength with the relay stations 20 and BS-signal strength RSS-BS, which is a signal strength with the base station 30, from the mobile stations 10, along with the inter-frequency hand-off request (S100); when the base stations 30 receive the inter-frequency hand-off request, acquiring empty channel information receiving cognitive radio band information including the empty channel information by requesting the cognitive radio band information to the relay stations 20 having the empty channel information based on a cognitive radio technology (S200); calculating RS-throughput DR-RS corresponding to data throughput between the relay stations 20 and BS-throughput DR-BS corresponding to data throughput between the base stations 30 by using the information on the RS-signal strength RSS-RS with the relay station 20 and the BS-signal strength RSS-BS with the base station 30 and the empty channel state information in the cognitive radio band information (S300); and when the RS-throughput DR-RS is higher than the BS-throughput DR-BS, instructing the mobile stations 10 to perform the inter-frequency hand-off (S400); and allowing the mobile stations 10 to perform the inter-frequency hand-off according to the inter-frequency hand-off instruction (S500).

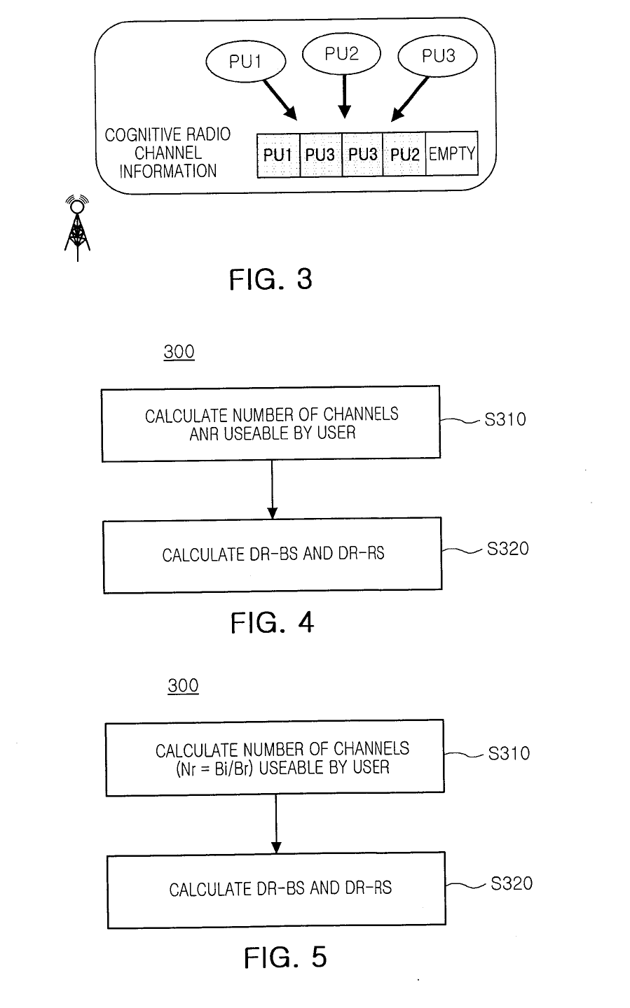

FIG. 3 is a structural diagram of cognitive radio channel information according to the present invention. Referring to FIG. 3, the cognitive radio channel information may include a plurality of channel information. In other words, some of a plurality of channels may include information occupied by existing users PU1, PU2, and PU3 and one of the plurality of channels may include, for example, empty channel information.

FIG. 4 is a flowchart illustrating the calculating of throughput according to the present invention.

Referring to FIG. 4, the calculating of the throughput (S300) includes: when exclusive authority exists in the empty channel state information, calculating the number of channels aNr useable by a cognitive user by using useable probability Pk of the cognitive user CU for each of the empty channels included in the cognitive radio band information (S310); and calculating the RS-throughput DR-RS and the BS-throughput DR-BS, respectively, by using the number of channels aNr and the information on the RS-signal strength RSS-BS with the relay station 20 and the BS-signal strength RSS-BS with the base station 30 (S320).

FIG. 5 is a flowchart showing the calculating of throughput according to the present invention.

Referring to FIG. 5, the calculating of the throughput (S300) includes: when exclusive authority does not exist in the empty channel state information, calculating the number of maximally useable channels Nr in the range where an interference temperature TI, occurring between the cognitive user CU for each of the empty channels included in the cognitive radio band information and the existing user PU occupying the existing band, does not exceed a predetermined interference threshold TL (S310); and calculating the RS-throughput DR-RS and the BS-throughput DR-BS, respectively, by using the number of maximally useable channels Nr and the information on the RS-signal strength RSS-RS with the relay station 20 and the BS-signal strength RSS-BS with the base station 30 (S320).

Hereinafter, the actions and effects of the present invention will now be described in detail.

First, describing the method for controlling the inter-frequency hand-off in the cognitive radio based cellular relay communications network of the present invention with reference to FIGS. 2 through 5, in the requesting of the inter-frequency hand-off (S80) the mobile station 10 requests the base station 30 to perform the inter-frequency hand-off in the case of the shadow area.

In other words, the mobile station 10 measures the BS-signal strength RSS-BS corresponding to the signal strength with the base station 30 and the RS-signal strength RSS-BS corresponding to the signal strength with the relay station 20, respectively, based on the signal strength through the transmission and reception of the signal, and determines it as a shadow region when the RS-signal strength RSS-RS is larger than the BS-signal strength RSS-BS.

Herein, in the cellular relay communications network to which the present invention is applied, the relay station 20 collects the radio channel state information by using cognitive radio technology known in the art.

For example, as shown in FIG. 3, some of the plurality of channels may include information occupied by the existing users PU1, PU2, and PU3 and one channel may include empty channel information.

Next, the base station 30 receives the inter-frequency hand-off request from the mobile station 10 and receives the information on the RS-signal strength RSS-RS and the BS-signal strength RSS-BS from the mobile station 10 (S100).

Thereafter, when the base station 30 receives the inter-frequency hand-off request, the acquiring of the empty channel information (S200) of the present invention includes requesting the cognitive radio band information to the relay station 20 having the empty channel information based on the cognitive radio technology to receive the cognitive radio band information including the empty channel information from the relay station 20.

At this time, as described with reference to FIG. 3, the cognitive radio channel information may include a plurality of pieces of channel information. In other words, some of a plurality of channels may include information occupied by existing users PU1, PU2, and PU3 and one of the plurality of channels may include empty channel information.

Then, the calculating of the throughput (S300) of the present invention calculates the RS-throughput DR-RS corresponding to the data throughput between the relay stations and the BS-throughput DR-BS corresponding to the data throughput between the base stations by using the information on the RS-signal strength RSS-RS and the BS-signal strength RSS-BS and the empty state information in the cognitive radio band information.

Next, at the instructing of the inter-frequency hand-off (S400) of the present invention, the base station 30 instructs the mobile station 10 to perform the inter-frequency hand-off when the RS-throughput DR-RS is higher than the BS-throughput DR-BS.

Thereafter, at the performing of the inter-frequency hand-off (S500) of the present invention, the mobile station 10 performs the inter-frequency hand-off according to the inter-frequency hand-off instruction. In other words, the mobile station 10 can perform communications by using the radio channel that is the empty channel provided from the relay station 20, such that it can avoid channel interference with the base station 30.

The calculating of the throughput (S300) can calculate the RS-throughput DR-RS and the BS-throughput DR-BS through the process as shown in FIG. 4 or calculate the RS-throughput DR-RS and the BS-throughput DR-BS through the process shown in FIG. 5, according to the channel state.

Referring to FIG. 4, in the calculating of the throughput (S300), when the exclusive authority exists in the empty channel state information, the calculating of the number of channels (S310) calculates the number of channels aNr (see the following Equation 2) useable by the cognitive user by using the useable possibility Pk (see the following Equation 1) of the CU (cognitive user) for each of the empty channels included in the cognitive radio band information.

$$\begin{matrix}Pk = \frac{{( λ / μ )}^{k} / k !}{{\sum }_{i = 0}^{{N}^{′}} {( λ / μ )}^{′} / i !} & Equation 1 \\ aNr = 1 \cdot {P}_{{N}_{r} - 1} + 2 \cdot {P}_{{N}_{r} - 2} + 3 \cdot {P}_{{N}_{r} - 3} + … + {N}_{r} \cdot {P}_{0} & Equation 2\end{matrix}$$

In Equations 1 and 2, Pk is the useable probability of CU (cognitive user), λ is a wavelength of frequency, μ is permeability, a is useable channel parameter, and Nr is the number of channels of interest band.

Referring to FIG. 4, the calculating of the throughput (S320) calculates the RS-throughput DR-RS and the BS-throughput DR-BS, respectively, according to the following Equations 3 and 4, by using the number of channels aNr and the information on the RS-signal strength RSS-RS with the relay station 20 and the BS-signal strength RSS-BS with the base station 30.

$$\begin{matrix}DR \text{-} RS = {aN}_{r} {B}_{r} log [ 1 + \frac{RSS - RS}{1 + {N}_{th}} ] & Equation 3 \\ DR \text{-} BS = τ {N}_{c} {B}_{c} log [ 1 + \frac{RSS - BS}{1 + {N}_{th}} ] & Equation 4\end{matrix}$$

In Equations 3 and 4, t is the frequency reuse coefficient, Nc is the number of channels of a cellular band, Br is bandwidth per channel of interest band and Bc is bandwidth per channel of a cellular band.

Referring to FIG. 5, at the calculating of the throughput, the calculating of the bandwidth (S300), the calculating of the bandwidth (S310) obtains the maximally useable bandwidth (Bi=Nr*Br) in the range where an interference degree TI occurring between the cognitive user CU for each of the empty channels included in the cognitive radio band information and the existing user PU occupying the existing band does not exceed the predetermined interference threshold TL by using the following Equation 5 when exclusive authority does not exist in the empty channel state information,

$$TI ( fi , Bi ) + \frac{MiP}{kBi} \leq TL , 1 \leq i \leq n \qquad Equation 5$$

In Equation 5, TL is interference threshold, meaning the limitation of the interference temperature of the transmitter of a cellular user CU, P is the transmission output of cellular user, Bi is spectrum bandwidth (=Nr*Br) in which existing ith user PU is interfered with a cellular user CU, fi is the central frequency of a spectrum in which existing ith user PU is interfered with a cellular user, Mi is channel gain generated due to fading between transmitter of cellular user CU and receiver of existing user PU, and K is the Boltzmann constant.

Referring to Equation 5, if the maximally useable bandwidth (Bi=Nr*Br) is known, the number of maximally useable channels can be obtained.

In other words, the relay station 20 can calculate its own maximum transmission bandwidth Bi satisfying the interference threshold TL. The reason why the CR (cognitive radio) device obtains its own use bandwidth in a ‘bandwidth’ unit, not a ‘channel’ unit is as follows. The reason is that in ‘the band where all the devices can freely access without an exclusive user’, each communications device (including CR (cognitive radio) device can use a bandwidth without limiting the number of channels within the range in which the band is defined (for example, in the case of an ISM band that is a representative free band, the bandwidth is defined by 2.4 GHz to 2.4835 GHz, such that each communications device may use all the bands at the same time according to situations).

Each CR (cognitive radio) device will use the maximum bandwidth within the range where the interference of the threshold or less has an effect on the existing user PU. However, the bandwidth obtained as described above can be dispersed into the unit channel and the number of unit channels, such that the calculated maximum possible bandwidth can be represented by ‘Bi=Nr*Br’.

In this case, the number of useable channels ‘Nr’ can be obtained by dividing the calculated maximum value ‘Bi’ by ‘Br’ that is the unit bandwidth, that is, Nr=Bi/Br.

As described above, the obtained value of the number of maximally useable channel Nr is transmitted to the base station 30.

Subsequently, referring to FIG. 5, the calculating of the throughput (S320) calculates the RS-throughput DR-RS and the BS-throughput DR-BS, respectively, according to the following Equations 6 and 7, by using the maximum transmission bandwidth Br and the information on the RS-signal strength RSS-RS with the relay station 20 and the BS-signal strength RSS-BS with the base station 30.

$$\begin{matrix}DR \text{-} RS = {N}_{r} {B}_{r} log [ 1 + \frac{RSS - RS}{1 + {N}_{th}} ] & Equation 6 \\ DR \text{-} BS = τ {N}_{c} {B}_{c} log [ 1 + \frac{RSS - BS}{1 + {N}_{th}} ] & Equation 7\end{matrix}$$

In the present invention as described above, the RS (relay station) uses a band different from the cellular frequency band used by the BS (base station) to provide services to the MS (mobile station), in order to remove the frequency interference with the base station BS.

At this time, the relay station collects the channel information of the radio channels by using the CR (cognitive radio) technology to have the cognitive radio channel information including the information on whether the channel is occupied or emptied.

In addition, the data throughput with the base station and the data throughput with the relay station, respectively, are calculated according to the channel occupying characteristic or the channel occupying type of the existing user PU in the interest radio band to determine whether or not to instruct the final inter-frequency hand-off.

As set forth above, according to exemplary embodiments of the invention, the inter-frequency hand-off is performed by using the empty channels based on CR (cognitive radio) technology, thereby making it possible to reduce the inter-channel signal interference and improve the signal throughput in the complex multi-cell network.

Frequency resource management in the relay communications network in which the RS (relay station) using the CR (cognitive radio) exists can therefore be facilitated. Further, the present invention can be applied to the multi-cell environment where the system using the CR (cognitive radio) exists in an independent cell form, rather than inside the cell.

For example, when the base station uses the fixedly allocated frequency band and the relay station performs the inter-frequency hand-off from the cell in which the mobile station uses the fixedly allocated frequency band to the cell using the cognitive radio in a multi-cell environment where the relay system or various types of systems in the form using the cognitive radio are mixed, the method for controlling the inter-frequency hand-off according to the present invention can be used.

The present invention can therefore provide mobile communications services requiring high throughput even in a complicated environment that includes many high-rise buildings or many high-speed mobile objects, by improving the throughput of the area in which where services are difficult to provide only through the use of a base station. In addition, the present invention efficiently uses the resources by the system using frequency resources which are not used at a specific time and a specific place by using the cognitive radio technology, thereby making it possible to contribute to the growth of green technology within the IT technology.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for controlling an inter-frequency hand-off in a cognitive radio based cellular relay communications network, comprising:
receiving the inter-frequency hand-off request from mobile stations and receiving information on RS-signal strength, which is a signal strength with relay stations, and BS-signal strength, which is a signal strength with the base stations, from the mobile stations;
acquiring empty channel information receiving cognitive radio band information including the empty channel information by requesting the cognitive radio band information to the relay stations having the empty channel information based on a cognitive radio technology when the base stations receive the inter-frequency hand-off request;
calculating RS-throughput corresponding to data throughput between the relay stations and BS-throughput corresponding to data throughput between the base stations by using the information on the RS-signal strength and the BS-signal strength and empty channel state information in the cognitive radio band information; and
instructing the mobile station to perform the inter-frequency hand-off when the RS-throughput is higher than the BS-throughput.

2. The method for controlling the inter-frequency hand-off in the cognitive radio based cellular relay communications network of claim 1, wherein the calculating of the throughput comprises:
calculating the number of channels useable by a cognitive user by using a useable probability of the cognitive user for each of the empty channels included in the cognitive radio band information when exclusive authority exists in the empty channel state information; and
calculating the RS-throughput and the BS-throughput, respectively, by using the number of channels and the information on the RS-signal strength and the BS-signal strength.

3. The method for controlling the inter-frequency hand-off in the cognitive radio based cellular relay communications network of claim 1, wherein the calculating of the throughput comprises:
when exclusive authority does not exist in the empty channel state information, calculating the number of maximally useable channels in the range in which an interference temperature occurring between the cognitive user and the existing user for each of the empty channels included in the cognitive radio band information does not exceed a predetermined interference threshold; and
calculating the RS-throughput and the BS-throughput, respectively, by using the number of maximally useable channels and the information on the RS-signal strength and the BS-signal strength.

4. A method for controlling an inter-frequency hand-off in a cognitive radio based cellular relay communications network, comprising:
requesting inter-frequency hand-off to base stations from mobile stations in the case of a shadow area;
receiving a inter-frequency hand-off request from the mobile stations and receiving information on RS-signal strength, which is signal strength with relay stations and BS-signal strength, which is a signal strength with the base station, from the mobile stations, along with the inter-frequency hand-off request;
acquiring empty channel information receiving cognitive radio band information including the empty channel information by requesting the cognitive radio band information to the relay stations having the empty channel information based on a cognitive radio technology when the base stations receive the inter-frequency hand-off;
calculating RS-throughput and BS-throughput by using the information on the RS-signal strength and the BS-signal strength and the empty channel state information in the cognitive radio band information;
instructing the mobile station to perform the inter-frequency hand-off when the RS-throughput is higher than the BS-throughput; and
allowing the mobile stations to perform the inter-frequency hand-off according to the inter-frequency hand-off instruction.

5. The method for controlling the inter-frequency hand-off in the cognitive radio based cellular relay communication of claim 4, wherein the calculating of the throughput comprises:
calculating the number of channels useable by a cognitive user by using useable probability of the cognitive user for each of the empty channels included in the cognitive radio band information when exclusive authority exits in the empty channel state information; and
calculating the RS-throughput and the BS-throughput, respectively, by using the number of channels and the information on the RS-signal strength and the BS-signal strength.

6. The method for controlling the inter-frequency hand-off in the cognitive radio based cellular relay communications of claim 4, wherein the calculating of the throughput comprises:
when the exclusive authority does not exist in the empty channel state information, calculating the number of maximally useable channels in the range where an interference temperature occurring between the cognitive user and the existing user for each of the empty channels included in the cognitive radio band information does not exceed a predetermined interference threshold; and
calculating the RS-throughput and the BS-throughput, respectively, by using the number of maximally useable channels and the information on the RS-signal strength and the BS-signal strength.
